(19) United States
(12) Patent Application Publication
(10) Pub. No.: US 2003/0189594 A1
(43) Pub. Date: Oct. 9, 2003

(54) Dynamic text visibility program

(75) Inventor: Steven Paul Jones, Rochester, MN (US)

Correspondence Address: Robert R. Williams, IBM Corporation, Dept. 917, 3605 Highway 52 North, Rochester, MN, 55901-7829, US

(73) Assignee: International Business Machines Corporation, Armonk, NY (US)

(21) Appl. No.: 10/116,229

(22) Filed: Apr. 4, 2002

(51) Int. Cl. G09G 5/00

(52) U.S. Cl. 345/764; 345/805

(57) ABSTRACT

Embodiments of the present invention are generally directed to a method of displaying a user activity site contained within an active window on a display screen. In one aspect, a detection is made as to whether the user activity site is obstructed by an obstruction. If so, the user activity site is displayed in a text display area disposed in front of the obstruction. The obstruction comprises one or more inactive windows.

### BACKGROUND OF THE INVENTION

1. Field of the Invention

The present invention generally relates to computers and computer software. More specifically, the invention is generally related to maintaining the visibility of user activity on a display screen of an output device.

2. Description of the Related Art

Users of computer systems often operate within windows environments. A window is a defined area containing text, images and other content and displayable on an output device, such as a cathode ray tube (CRT). Windows provide a convenient means for displaying various content simultaneously on the output device. Using multiple open windows, a user can efficiently view and/or operate on the content contained in each window. For example, a first window may provide an interface for a word processing program while a second window contains instructions for operating the processing program. Thus, the user can view the instructions in the second window while simultaneously carrying out the instructions in the first window.

One problem that frequently occurs in a windows environment is that the windows will interfere with one another. Consider, for example, a user operating a processing program who desires to access a Help menu. If the processing program currently occupies all of (or sometimes less than all of) the viewable screen area, the Help menu window will be opened on top of the processing program window. Accordingly, a portion of the processing program window will no longer be viewable to the user. In some cases, this would be unacceptable to the user, particularly when the user desires to see or place text on the portion of the processing program window currently covered by the Help menu window, e.g., when the user continues to type into the portion of the program window that is currently covered by the Help menu window.

One solution to the foregoing predicament is to allow the user to toggle between each of the windows. For example, when the user desires to resume typing, the processing program window may be brought to the foreground with a mouse click, a sequence of keystrokes (e.g., a hotkey) or other user-initiated events. However, such a solution is unacceptable because of the resulting inefficiency in requiring the user to continuously toggle between the windows. Additionally, the advantages provided by windows are substantially reduced because the user is required to select an active window and sacrifice all other open windows.

Therefore, there is a need for a method, article of manufacture and system adapted to address the problems associated with a windows environment and the simultaneous use of multiple windows.

### SUMMARY OF THE INVENTION

Embodiments of the present invention are generally directed to a method of displaying a user activity site contained within an active window on a display screen. In one aspect, a detection is made as to whether the user activity site is obstructed by an obstruction. If so, the user activity site is displayed in a text display area disposed in front of the obstruction. In one embodiment, the obstruction comprises one or more inactive windows.

One embodiment of the present invention provides a method of displaying a user activity site contained within an active window on a viewable screen area of an output device. A determination is made as to the likelihood that the user activity site will move into an unviewable portion of the active window. If the likelihood exists, the user activity site is wrapped to one or more subsequent lines in the active window.

Another embodiment of the present invention provides a signal bearing medium containing a program which, when executed by one or more processors, performs a method for displaying a user activity site contained within an active window on a display screen. The method includes the steps of: detecting whether the user activity site is obstructed by an obstruction; and if so, displaying the user activity site in a text display area disposed in front of the obstruction.

Yet another embodiment of the present invention provides a signal bearing medium containing a program which, when executed by one or more processors, performs a method for displaying a user activity site contained within an active window on a viewable screen area of an output device. The method includes the steps of: determining a likelihood that the user activity site will move into an unviewable portion of the active window; and if the likelihood exists, wrapping the user activity site to one or more subsequent lines in the active window.

Still another embodiment of the present invention provides a computer system comprising a display device, a memory and one or more processors configured to execute one or more programs supporting a windows environment comprising an active window within a viewable screen area of an output device. When executed, the programs perform a method that includes the steps of: detecting whether the user activity site is obstructed by an obstruction; and if so, displaying the user activity site in a text display area disposed in front of the obstruction.

Yet still another embodiment of the present invention provides a computer system comprising a display device, a memory and one or more processors configured to execute one or more programs supporting a windows environment comprising an active window within a viewable screen area of an output device. When executed, the programs perform a method that includes the steps of: determining a likelihood that the user activity site will move into an unviewable portion of the active window; and if the likelihood exists, wrapping the user activity site to one or more subsequent lines in the active window.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level diagram of a computer system consistent with an embodiment of the invention;

FIG. 2 is an illustrative graphical user interface which can be used to provide user-selectable options in accordance with an embodiment of the invention;

FIGS. 3A-D illustrate a text display area feature in accordance with an embodiment of the present invention;

FIGS. 4A-4B illustrate another text display area feature in accordance with an embodiment of the present invention;

FIGS. 5A-5B illustrate a text display area disposed in front of an inactive window when the inactive window obscures user activity within an active window in accordance with an embodiment of the present invention;

FIGS. 6A-6B illustrate the premature wrap feature in accordance with an embodiment of the present invention;

FIGS. 7A-7B illustrate the premature wrap feature in accordance with an embodiment of the present invention;

FIGS. 8A-8B illustrate the premature wrap feature and the text display area feature in operation at the same time in accordance with an embodiment of the present invention; and

FIGS. 9A-9B illustrate a method performed by the dynamic text visibility program when executed by the processor in accordance with an embodiment of the invention.

### DETAILED DESCRIPTION OF THE PREFERRED EMBODIMENTS

The present invention is directed to various embodiments of a method, article of manufacture and system for displaying a user activity site contained within an active window on a display screen of an output device. In some embodiments, the user activity is defined herein by the location of an activity site (e.g., a cursor, text, or a mouse pointer). Various embodiments of the present invention are configured to ensure that the user activity remains visible to the user. In one embodiment, a window displaying the user activity site is displayed in front of the inactive window that is covering the user activity site contained within the active window. In another embodiment, the user activity site is prematurely wrapped to the next lines within the active window.

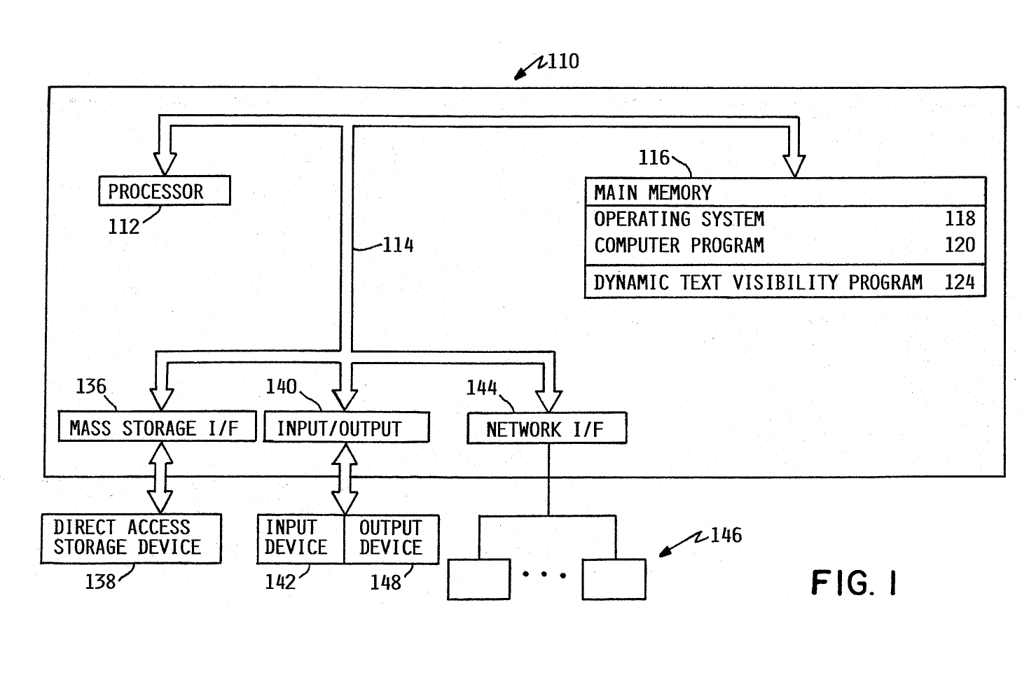

One embodiment of the invention is implemented as a program product for use with a computer system such as, for example, the computer system 110 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Referring now to FIG. 1, a computer system 110 consistent with the invention is shown. For purposes of the invention, the computer system 110 may represent any type of computer, computer system or other programmable electronic device, including a client computer, a server computer, a portable computer, an embedded controller, etc. The computer system 110 may be a standalone device or networked into a larger system. In one embodiment, the computer system 110 is an AS/400 available from International Business Machines of Armonk, N.Y.

The computer system 110 is shown for a multi-user programming environment that includes at least one processor 112, which obtains instructions and data via a bus 114 from a main memory 116. The system 110 could be a PC-based server, a minicomputer, a midrange computer, a mainframe computer, etc. adapted to support the methods, apparatus and article of manufacture of the invention.

The main memory 116 includes an operating system 118, a computer program 120, and a dynamic text visibility program 124. In addition, various data structures (none shown) may be resident in the main memory 116. The main memory 116 could be one or a combination of memory devices, including Random Access Memory, nonvolatile or backup memory, (e.g., programmable or Flash memories, read-only memories, etc.). In addition, the main memory 116 may be considered to include memory physically located elsewhere in a computer system 110, for example, any storage capacity used as virtual memory or stored on a mass storage device or on another computer coupled to the computer system 110 via the bus 114. While the main memory 116 is shown as a single entity, it should be understood that main memory 116 may in fact comprise a plurality of modules, and that the main memory 116 may exist at multiple levels, from high speed registers and caches to lower speed but larger DRAM chips.

The dynamic text visibility program 124 facilitates the visibility of dynamic text displayed on an output device 148. The dynamic text visibility program 124 may be a separate software component of the computer system 110. Alternatively, the dynamic text visibility program 124 may be a sub-component of the operating system 118 or any other software product executing on the computer system 110.

The computer system 110 can be connected to a number of operators and peripheral systems. Illustratively, the computer system 110 includes a storage device 138, input devices 142, output devices 148, and a plurality of networked devices 146. Each of the peripheral systems is operably connected to the computer system 110 via interfaces 136, 140 and 144. In one embodiment, the storage device 138 is DASD (Direct Access Storage Device), although it could be any other storage such as floppy disc drives or optical storage. Even though the storage device 138 is shown as a single unit, it could be any combination of fixed and/or removable storage devices, such as fixed disc drives, floppy disc drives, tape drives, removable memory cards, or optical storage. The input devices 142 can be any device to give input to the computer system 110. For example, a keyboard, keypad, light pen, touch screen, button, mouse, track ball, or speech recognition unit could be used. The output devices 148 include any conventional display screen and, although shown separately from the input devices 142, the output devices 148 and the input devices 142 could be combined. For example, a display screen with an integrated touch screen, and a display with an integrated keyboard, or a speech recognition unit combined with a text speech converter could be used.

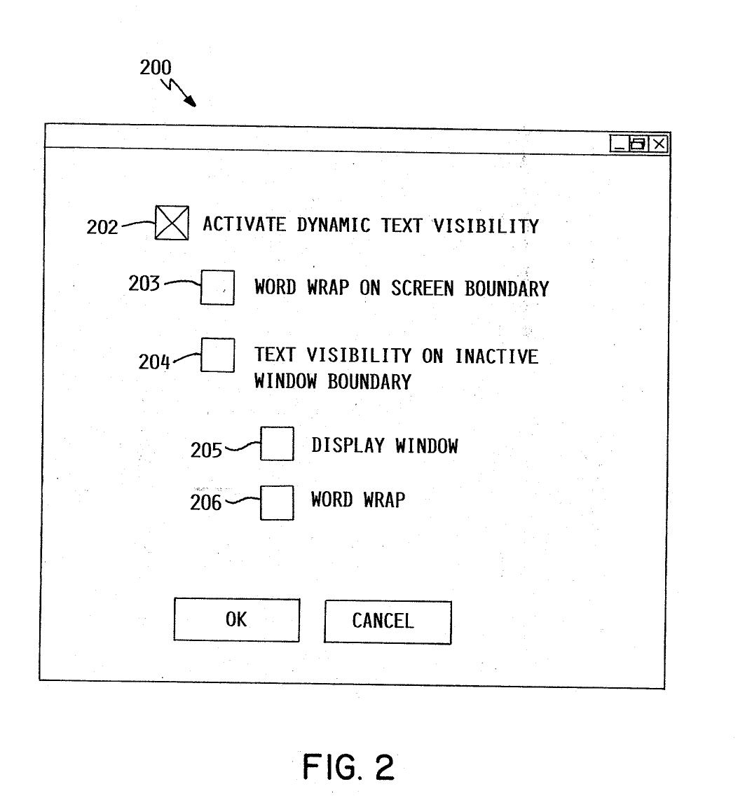

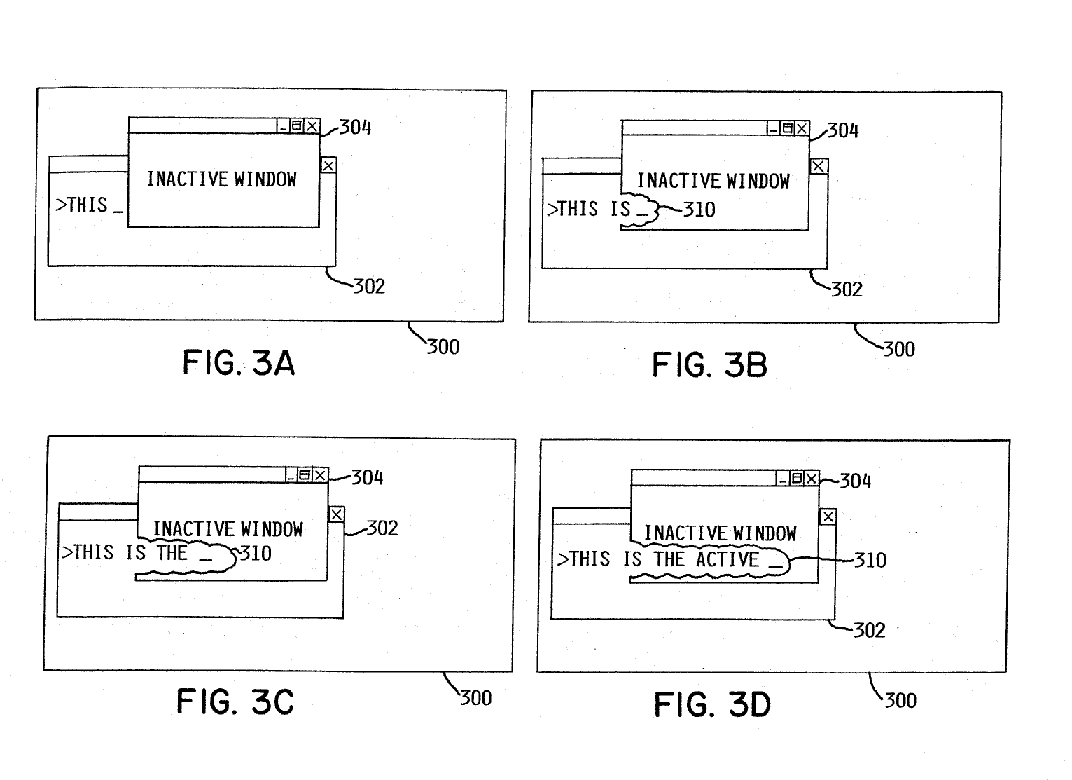

Referring now to FIG. 2, a graphical user interface 200 in accordance with an embodiment of the present invention is illustrated. In one embodiment, the operation of the dynamic text visibility program 124 is at least partially defined by user-selected parameters. The parameters may be provided to the computer system 110 via graphical user interfaces (GUIs) displayable on the output devices 148. One illustrative GUI 200 is shown in FIG. 2. The GUI 200 is formatted as a window containing multiple checkboxes selectable by the user. An “ACTIVATE DYNAMIC TEXT VISIBILITY” checkbox 202 allows the user to select the inventive dynamic text visibility feature. If the checkbox 202 is selected, the remaining checkboxes then become available for the user's selection. Once the user selects the checkbox 202, the user has the option to select two additional boxes, i.e., a checkbox 203 and a checkbox 204. Checkbox 203 addresses the situation in which the user activity site is or is about to be obstructed by a region outside the screen boundary. If the checkbox 203 is selected, the user activity site, e.g., the cursor and text, in a visible portion of the active window will prematurely wrap around to the next line in the visible portion of the active window prior to being obstructed by the region outside the screen boundary. If the checkbox 204 is selected, the user will have the option to select two additional boxes, i.e., a checkbox 205 and a checkbox 206. Checkbox 204 addresses a situation in which the user activity site is obstructed by an inactive window or about to be obstructed by the inactive window. If the checkbox 205 is selected, the user activity site that is or is about to be obstructed by the inactive window will be displayed in a text display area disposed in front of the inactive window. In one embodiment, the text display area is disposed in a foreground. If the checkbox 206 is selected, the user activity site, e.g., the cursor and text, in the visible portion of the active window will prematurely wrap around to the next line in the visible portion of the active window prior to being obstructed by the inactive window. Details of the above features of the embodiments of the present invention will be discussed in the following paragraphs with reference to FIGS. 3A-9B.

It should be understood that the user selectable parameters described with reference to the GUI 200 are merely illustrative. Other user selectable parameters may be provided and used to the advantage of the present invention. For example, in one embodiment, the user may be given the option to select the amount of margin surrounding the text appearing in the text display area disposed in front of the inactive window. In another embodiment, the user may be given the option to select the threshold distance used to determine a likelihood of a user activity site moving into a view-obstructing area. It should also be understood that additional user selectable parameters may be made available through a GUI (such as GUI 200) to control these and other situations.

Referring now to FIGS. 3A-3D, an illustration of the text display area feature in accordance with an embodiment of the present invention is shown. FIG. 3A illustrates a display area 300, which may be a viewable screen area of a monitor. The display area 300 contains an active window 302 and an inactive window 304. The inactive window 304 substantially overlaps the active window 302. FIG. 3A further illustrates that a user has already typed the word “THIS” on the active window 302. If the user continues to type, the text subsequent to “THIS” will quickly disappear behind the inactive window 304. However, if the program 124 is activated, e.g., by selecting the checkbox 205 on the GUI 200, the text subsequent to “THIS” will become visible to the user.

FIGS. 3B-3D illustrate the result of selecting the checkbox 205. In accordance with an embodiment of the present invention, as the user continues to type into the active window 302, the text that is covered by the inactive window 304 appears on/over/through the inactive window 304. That is, upon detection that the text being input to the active window 302 will move behind the inactive window 304, the program 124 displays that text on/over/through the inactive window 304. In one embodiment, the text is displayed in a text display area 310, e.g., in the form of a cloud, disposed in front of the inactive window 304. As an example, the text “IS” is displayed in the text display area 310 in FIG. 3B. As the amount of text increases, the size of the window 310 also increases. In one embodiment, the amount of margin (e.g., height and width) surrounding the text may also predetermined by the user. The text may also be displayed by other means. For instance, the text on the active window 302 may be copied to a portion of the inactive window 304 that covers/hides the text. In yet another embodiment, the portion of the inactive window 304 that covers the text may be made transparent so as to display the text on the active window 302 underneath the inactive window 304.

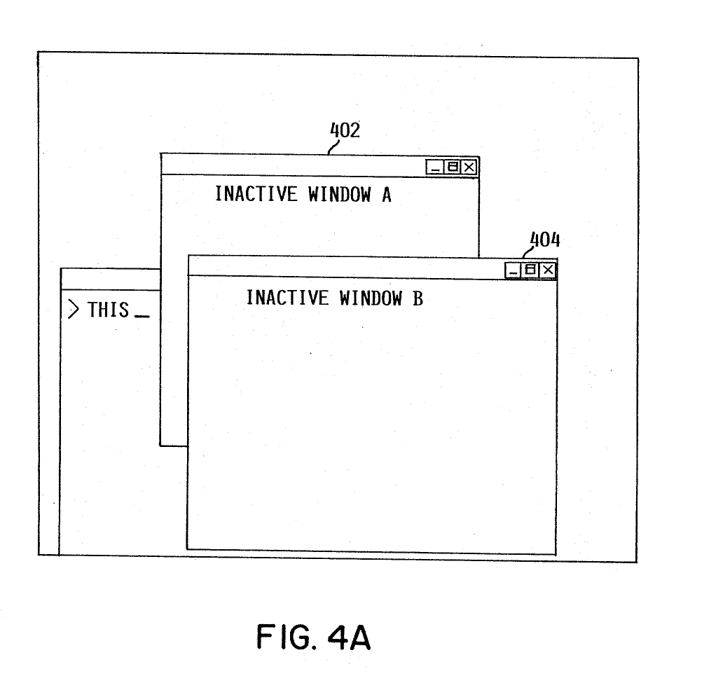

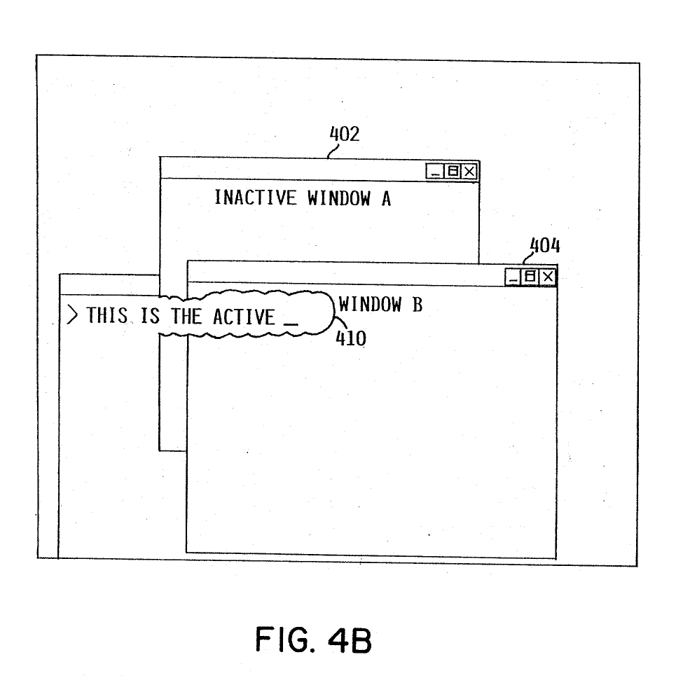

Although FIGS. 3A-3D depict only two windows, the invention can be used with any number of windows. FIGS. 4A-4B illustrate one embodiment of the invention in which the user activity site, e.g., the text “THE ACTIVE”, is displayed in a text display area 410 disposed in front of the two adjacent inactive windows 402 and 404.

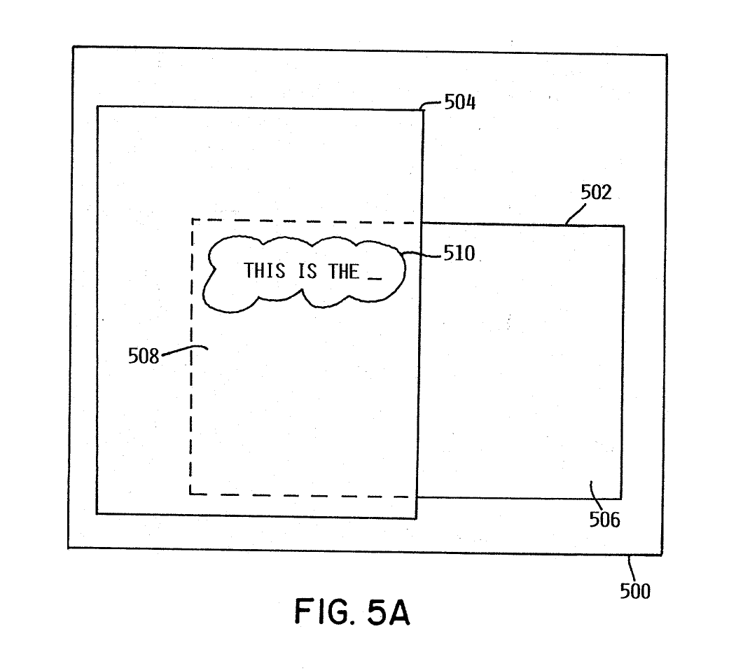

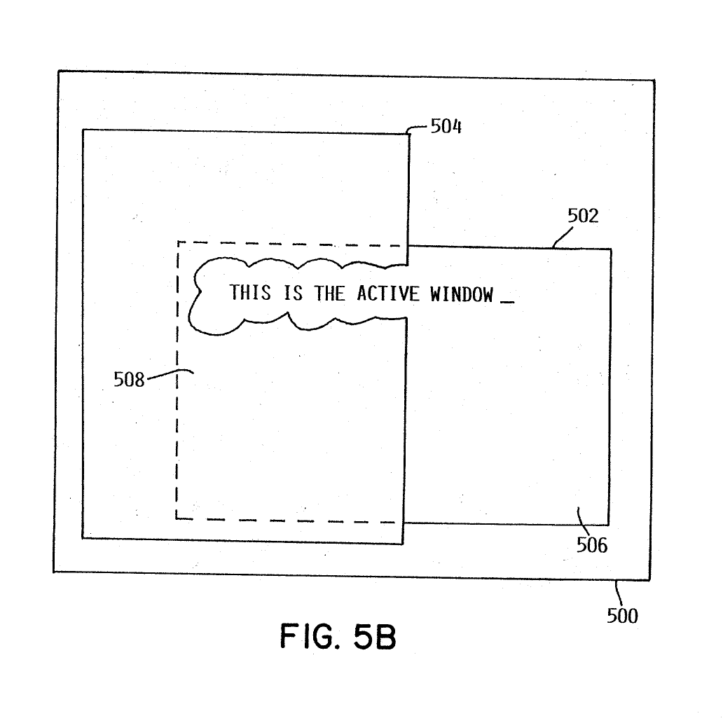

FIGS. 5A-5B illustrate an embodiment of the present invention in which a text display area 510 disposed in front of an inactive window 504 when the inactive window 504 obscures user activity within an active window 502. FIG. 5A illustrates a display area 500 that contains an active window 502 and an inactive window 504. The inactive window 504 substantially overlaps the active window 502. The active window 502 includes a viewable portion 506 and an unviewable portion 508 (represented by dashed lines). The user activity, e.g., the cursor with the text “THIS IS THE”, is contained in the unviewable portion 508. Conventionally, the user activity is not visible to the user until the user activity is moved into the viewable portion 506 of the active window 502. An embodiment of the invention, however, provides for displaying the user activity, i.e., the cursor with the text “THIS IS THE”, in the text display area 510 disposed in front of the inactive window 504 upon detection of the user activity within the unviewable portion 508.

FIG. 5B illustrates the situation in which the user activity extends over to the active window 502, e.g., the user types “ACTIVE WINDOW” after “THIS IS THE”. In accordance with an embodiment of the present invention, a portion of the text “ACTIVE WINDOW” continues to be displayed in the text display area 510 disposed in front of the inactive window 504 while the rest of the text “THE ACTIVE WINDOW” is displayed on the active window 502 in a conventional manner.

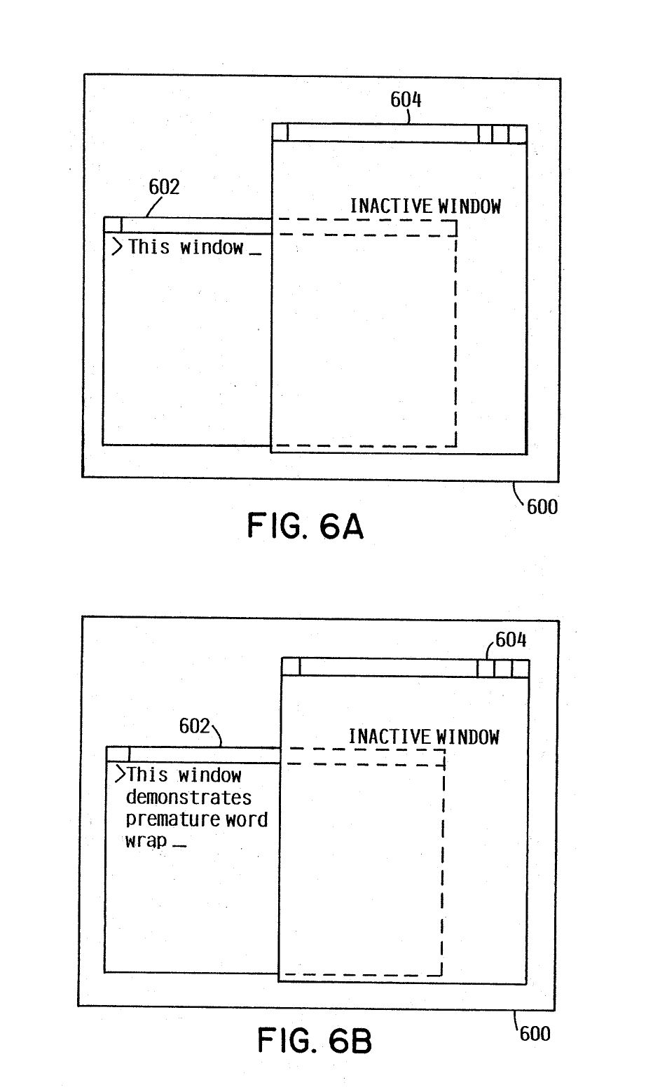

FIGS. 6A-6B illustrate the result of selecting the checkbox 206 (shown in the GUI 200 of FIG. 2). FIG. 6A illustrates a display area 600 that contains an active window 602 and an inactive window 604. The inactive window 604 substantially overlaps the active window 602. FIG. 6A further illustrates that a user has already typed the word “This window” on the active window 602. Conventionally, if the user continues to type, the text subsequent to “This window” will quickly disappear behind the inactive window 604. In accordance with an embodiment of the invention, however, upon detection that the text will move into a region behind the inactive window 604, the text subsequent to “This window”, i.e., “demonstrates premature word wrap”, will wrap around to the next three lines on the active window 602. Conventionally, the text will wrap around to the next line only when the text reaches the end of the active window 602. In this manner, the text “demonstrates premature word wrap” is prematurely wrapped to the next three lines on the active window 602 so as to display the text to the user.

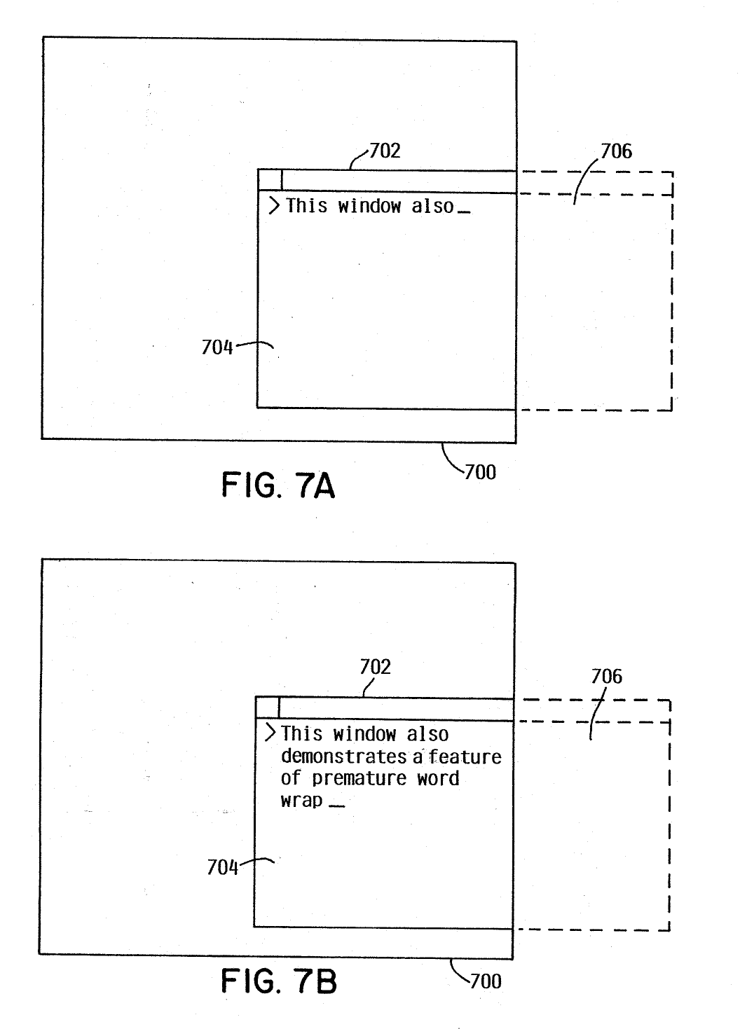

FIGS. 7A-7B illustrate an embodiment of the present invention in which the user activity site is prematurely wrapped to the next lines on an active window 702. As shown in FIG. 7A, the user activity site, i.e., the text “This window also”, is initially displayed as being contained in a viewable portion 704 of an active window 702 with the cursor being a single character removed from a right hand boundary of the display area 700. Conventionally, if the user continues to type, the cursor along with any subsequent text would move beyond the boundary of the display area 700 into the unviewable portion 706 of the active window 702. And consequently, the subsequent text would no longer be visible to the user. However, if the checkbox 203 has been selected, an embodiment of the present invention provides for wrapping the subsequent text to the next lines on the viewable portion 704 upon determining that the subsequent text will be positioned into a region outside of the viewable display area 700. And consequently, the text “demonstrates a feature of premature word wrap” is wrapped around to the next three lines on the viewable portion 704 of the active window 702.

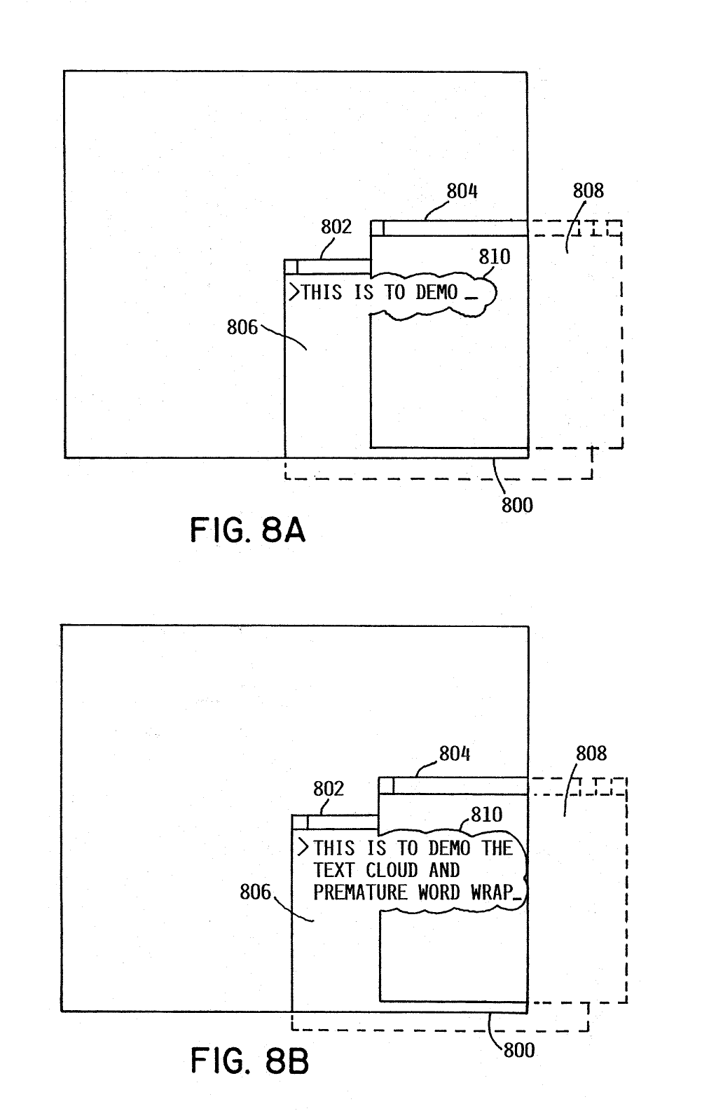

Referring now to FIG. 8A, a text display area 810 disposed in front of an inactive window 804 in accordance with an embodiment of the invention is illustrated. A portion of the user activity site, i.e., the text “This is to demo”, is initially displayed on a visible portion 806 of an active window 802 and the other portion is initially displayed in the text display area 810 disposed in front of the inactive window 804. The user activity site, however, is several characters removed from a right hand boundary of the display area 800. Conventionally, if the user continues to type, the cursor along with any subsequent text would move beyond the boundary of the display area 800 into the unviewable portion 808 of the inactive window 804. However, if checkboxes 203 and 205 have been selected, an embodiment of the present invention provides for wrapping the subsequent text to the next lines in the text display area 810 and the visible portion 806 of the active window 802 upon determining that the subsequent text will be positioned into a region outside of the viewable display area 800. The text “text cloud and premature word wrap” therefore is wrapped around to the next lines both in the text display area 810 and the viewable portion 806, as illustrated in FIG. 8B.

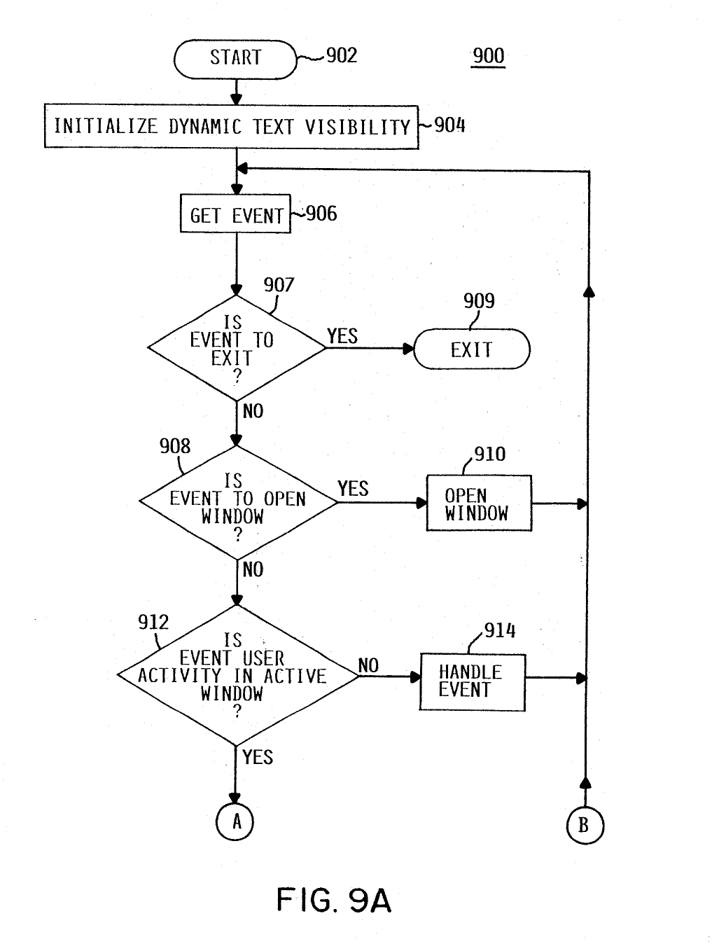

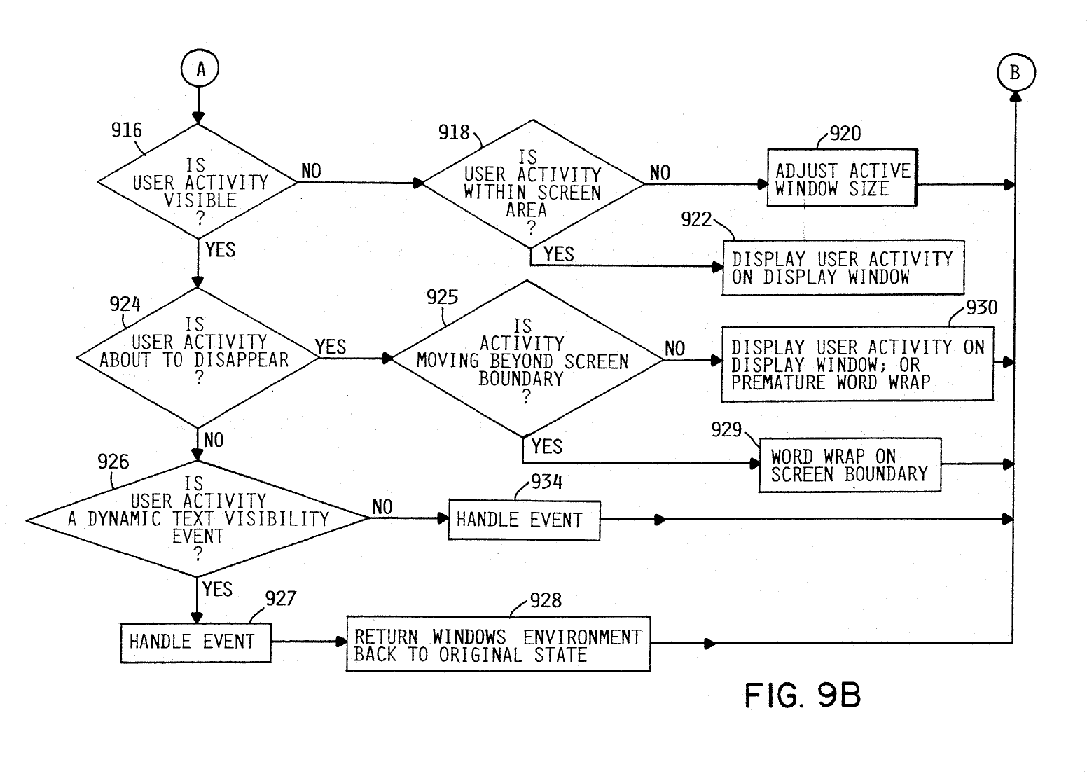

Referring now to FIGS. 9A-9B, a method 900 performed by the dynamic text visibility program 124 when executed by the processor 112 in accordance with an embodiment of the invention is shown. Illustratively, the method 900 assumes that a user is operating the computer program 120 and that the computer program 120 supports a windows environment.

The method 900 is entered at step 902 and proceeds to step 904 where the dynamic text visibility program is initialized. At step 906, the method 900 receives an event. At step 907, a query is made as to whether the event is to exit the method 900. If so, the method 900 is exited at step 909. Otherwise, processing proceeds to step 908.

At step 908, a query is made as to whether the event is to open a window. If so, the window is opened at step 910 and processing returns to step 906. Otherwise, processing continues to step 912 and a query is made as to whether the event is a user action in an active window (e.g., typing). If not, the event is handled appropriately at step 914.

Referring now to FIG. 9B, if step 912 is answered affirmatively, a determination is made as to whether the user activity is visible (step 916). The user activity may not be visible either when the cursor on the active window is behind an inactive window (such as when an inactive window is opened on top of an active window) or when the cursor is outside of the display area of the output device. Conventionally, the user may be able to continue typing but is unable to see a resulting textual output in the active window.

If step 916 is answered in the negative, processing proceeds to step 918 to query whether the user activity is within the screen area (i.e., contained within the screen boundaries) of the output device. If not (i.e., the user activity is on a region outside the screen boundary), then, at step 920, the size of the active window is adjusted so as to contain only the visible portion of the active window. The active window, therefore, is entirely within the screen boundary. The user activity from the unviewable portion of the active window is then moved to the visible portion of the active window. In this manner, the user activity site that was on a region outside the screen boundary becomes visible to the user. The active window remains in its adjusted size until the user moves the entire boundary of the active window into the display screen. Processing then returns to step 906.

If the user activity is contained within the screen area, the user activity is determined to be behind one or more inactive windows. If the user has selected the checkbox 205, processing proceeds to step 922 where the user activity is displayed in a text display area disposed in front of the one or more inactive windows. One embodiment of step 922 is described above with reference to FIGS. 5A-5B. Processing then returns to step 906.

If step 916 is answered affirmatively (i.e., the user activity is visible), a determination is then made as to whether the user activity is about to disappear (step 924) as a result of an obstruction. Such conditions were illustrated in FIGS. 3A-4B, FIGS. 6A-6B and FIGS. 7A-8B in which the user activity is at a threshold of a window or screen boundary. In one embodiment, the determination at step 924 comprises determining a distance between the user activity and the obstruction. The threshold distance may be measured as a number of alphanumeric characters, for example.

Accordingly, if step 924 is answered affirmatively, processing proceeds to determine whether the obstruction is a screen boundary or a window. At step 925, a determination is made as to whether the user activity is moving beyond a screen area boundary. If so, the user activity is prematurely wrapped to the next lines on the visible portion of the active window (at step 929). One embodiment of step 929 is described above with reference to FIGS. 7A-7B. Processing then returns to step 906.

If step 925 is answered negatively, then it is known that the obstruction is one or more inactive windows and that the user activity is on the threshold of moving behind the inactive windows. In accordance with an embodiment of the present invention, at step 930, the user activity may be displayed in a text display area disposed in front of the inactive windows, if the checkbox 205 has been selected. Further details of this embodiment may be found above with reference to FIGS. 3A-4B. In accordance with another embodiment of the present invention, at step 930, the user activity may be wrapped around to the next lines on the visible portion of the active window, if the checkbox 206 has been selected. Further details of this embodiment may be found above with reference to FIGS. 6A-6B. The method 900 may similarly determine obstructions other than a screen boundary and inactive window.

If step 924 is answered in the negative, processing proceeds to step 926 and a determination is made as to whether the user activity is a dynamic text visibility event. If the user activity is not a dynamic text visibility event, the event is handled in a conventional manner at step 934. Otherwise, processing proceeds to step 927 where the dynamic text visibility event is handled (e.g., a hard return is processed in response to the user striking the “Enter” key). At step 928, the windows environment is returned to its initial status prior to the dynamic text visibility event, e.g., the text display area disposed in front of the inactive windows is no longer displayed and the user activity is no longer prematurely wrapped on the active window. In one embodiment, the user is given the option to select whether returning the windows environment to its initial status is desired. Processing then returns to step 906.

The invention is described with reference to obstructions including inactive windows and screen area boundaries. However, the obstruction may be any limit or object, known or unknown in the art, which detrimentally affects a user's ability to view an activity site (e.g., a cursor) within a screen area.

While the foregoing is directed to embodiments of the present invention, other and further embodiments of the invention may be devised without departing from the basic scope thereof, and the scope thereof is determined by the claims that follow.

What is claimed is:

1. A method of displaying a user activity site contained within an active window in a display screen, comprising:
detecting whether the user activity site is obstructed by an obstruction; and
if so, displaying the user activity site in a text display area disposed in front of the obstruction.

2. The method of claim 1, wherein the obstruction comprises one or more inactive windows.

3. The method of claim 1, wherein displaying the user activity comprises bringing a portion of the active window containing the user activity site to a foreground.

4. The method of claim 1, wherein the text display area is an opening in the obstruction through which the site contained in the active window is made visible.

5. The method of claim 1, wherein the text display area comprises a margin around the user activity site.

6. The method of claim 1, wherein the user activity site comprises a cursor.

7. The method of claim 1, wherein the user activity site comprises a cursor and text.

8. The method of claim 1, wherein detecting whether the user activity site is obstructed by the obstruction comprises determining whether the user activity site is positioned behind one or more inactive windows.

9. The method of claim 1, further comprising:
detecting whether the user activity site will move into a region outside of the display screen; and
if so, wrapping the user activity site to one or more subsequent lines in the text display area.

10. A method of displaying a user activity site contained within a visible portion of an active window on a viewable screen area of an output device, comprising:
determining a likelihood that the user activity site will move into an unviewable portion of the active window; and
if the likelihood exists, wrapping the user activity site to one or more subsequent lines on the visible portion of the active window.

11. The method of claim 10, wherein the unviewable portion of the active window is positioned in a region selected from one of a region outside the viewable screen area and a region behind an inactive window.

12. The method of claim 10, wherein the user activity site comprises a cursor and the step of determining the likelihood comprises at least one of:
determining whether a distance between the cursor and an edge of an inactive window is a threshold number of characters; and
determining whether a distance between the cursor and a boundary of the viewable screen area is the threshold number of characters.

13. The method of claim 10, wherein the step of determining the likelihood comprises determining whether the user activity site will become hidden from a view of a user of the output device.

14. The method of claim 10, wherein the step of determining the likelihood comprises: determining whether the user activity site will move into a region behind an inactive window.

15. The method of claim 10, wherein the step of determining the likelihood comprises: determining whether the user activity site will move to a region outside of the viewable screen area.

16. The method of claim 10, wherein the user activity site comprises a cursor.

17. The method of claim 10, wherein the user activity site comprises a cursor and text.

18. The method of claim 10, wherein the step of determining the likelihood comprises: determining whether the user activity site will move into a region behind an inactive window; and wherein the user activity site comprises a cursor and text.

19. The method of claim 10, wherein the step of determining the likelihood comprises: determining whether the user activity site will move to a region outside of the viewable screen area; and wherein the user activity site comprises a cursor and text.

20. A signal bearing medium containing a program which, when executed by one or more processors, performs a method for displaying a user activity site contained within an active window on a display screen, the method comprising:
detecting whether the user activity site is obstructed by an obstruction; and
if so, displaying the user activity site in a text display area disposed in front of the obstruction.

21. The signal bearing medium of claim 20, wherein the obstruction comprises one or more inactive windows.

22. The signal bearing medium of claim 20, wherein displaying the user activity comprises bringing a portion of the active window containing the user activity site to a foreground.

23. The signal bearing medium of claim 20, wherein the method further comprises:
detecting whether the user activity site will move into a region outside of the display screen; and
if so, wrapping the user activity site to one or more subsequent lines in the text display area.

24. A signal bearing medium containing a program which, when executed by one or more processors, performs a method for displaying a user activity site contained within a visible portion of an active window on a viewable screen area of an output device, the method comprising:
determining a likelihood that the user activity site will move into an unviewable portion of the active window; and
if the likelihood exists, wrapping the user activity site to one or more subsequent lines on the visible portion of the active window.

25. The signal bearing medium of claim 24, wherein the user activity site comprises a cursor and the step of determining the likelihood comprises at least one of:
determining whether a distance between the cursor and an edge of an inactive window is a threshold number of characters; and
determining whether a distance between the cursor and a boundary of the viewable screen area is the threshold number of characters.

26. The signal bearing medium of claim 24, wherein the step of determining the likelihood comprises determining whether the user activity site will move into a region behind an inactive window.

27. The signal bearing medium of claim 24, wherein the step of determining the likelihood comprises determining whether the user activity site will move to a region outside of the viewable screen area.

28. A computer system comprising a display device, a memory and one or more processors configured to execute one or more programs supporting a windows environment comprising an active window within a viewable screen area of an output device; wherein when executed, the programs perform a method comprising:
detecting whether the user activity site is obstructed by an obstruction; and
if so, displaying the user activity site in a text display area disposed in front of the obstruction.

29. The system of claim 28, wherein the obstruction comprises one or more inactive windows.

30. The system of claim 28, wherein the text display area is an opening in the obstruction through which the site contained in the active window is made visible.

31. The system of claim 28, wherein the method further comprises:
detecting whether the user activity site will move into a region outside of the display screen; and
if so, wrapping the user activity site to one or more subsequent lines in the text display area.

32. A computer system comprising a display device, a memory and one or more processors configured to execute one or more programs supporting a windows environment comprising an active window within a viewable screen area of an output device; wherein when executed, the programs perform a method comprising:
determining a likelihood that the user activity site will move into an unviewable portion of the active window; and
if the likelihood exists, wrapping the user activity site to one or more subsequent lines on the visible portion of the active window.

33. The system of claim 32, wherein the user activity site comprises a cursor and the step of determining the likelihood comprises at least one of:
determining whether a distance between the cursor and an edge of an inactive window is a threshold number of characters; and
determining whether a distance between the cursor and a boundary of the viewable screen area is the threshold number of characters.

34. The system of claim 32, wherein the step of determining the likelihood comprises determining whether the user activity site will move into a region behind an inactive window.

35. The system of claim 32, wherein the step of determining the likelihood comprises determining whether the user activity site will move to a region outside of the viewable screen area.
